(19) United States
(12) Patent Application Publication
(10) Pub. No.: US 2013/0085790 A1
(43) Pub. Date: Apr. 4, 2013

(54) Organization of Group Attended Ticketed Event

(71) Applicant: Ebay Inc., San Jose, CA (US)

(72) Inventors: Andrew Palmer, Campbell, CA (US); Kartik V. Rao, Santa Clara, CA (US); Andrew Feierfeil, San Jose, CA (US); Matan Bar, Tel Aviv (IL)

(73) Assignee: EBAY INC., San Jose, CA (US)

(21) Appl. No.: 13/631,450

(22) Filed: Sep. 28, 2012

Related U.S. Application Data
(60) Provisional application No. 61/540,904, filed on Sep. 29, 2011.

(51) Int. Cl. G06Q 10/02

(52) U.S. Cl. CPC G06Q 10/02
USPC 705/5

(57) ABSTRACT

Computing systems and methods for organizing group attended ticketed events. A computing system includes one or more memory device or storage components adapted to store user information regarding users of the computing system as well as event information regarding upcoming ticketed events, and one or more processors for conducting activities regarding ticketing for group members. Such activities include displaying information regarding a ticketed event, accepting a user input for inviting invitees to the ticketed event, communicating invitations to the invitees based on the input, receiving invitee response information from the invitees regarding interest in attending the ticketed event, and accepting a purchase request for tickets to the ticketed event from the user, wherein the purchase request is based at least in part on the invitee response information.

### CROSS REFERENCE TO RELATED APPLICATION

This application claims priority from co-pending and commonly owned U.S. Provisional Application No. 61/540,904, entitled “GROUP TICKETING,” filed Sep. 29, 2011, naming Palmer et al. as inventors, the full disclosure of which is incorporated by reference herein in its entirety and for all purposes.

### TECHNICAL FIELD

The present disclosure relates generally to electronic commerce, and more particularly to electronic systems and methods for assisting users in activities relating to ticketed events attended by groups.

### BACKGROUND

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket. Many different websites and parties buy, sell and provide marketplaces for tickets online, and the ability for individuals to buy and sell tickets online is now generally well known. These tickets can be for a variety of live events, such as, for example, sports, concerts, theater, and other entertainment events. While finding and acquiring event tickets can be relatively simple for a small number of people, such a process can be more of a challenge for larger groups.

Unfortunately, the process for a person desiring to organize a group to attend a ticketed event can often be cumbersome. For example, upon finding out about a given event, other actions can include reaching out to family or friends to see who is interested, searching online to see what tickets may be available, checking back with the interested family or friends to see if the available seats are acceptable, and then purchasing or otherwise obtaining the tickets online. Further actions can then include organizing travel plans to get to the event, deciding what to bring, attending the actual event and taking part in its festivities, and then collecting money from the family or friends that use the tickets. In addition, activities after the event can include looking up, providing or posting pictures, videos or reviews online.

Although many systems and methods for purchasing tickets and attending ticketed events in groups have generally worked well in the past, there is always a desire for improvement. In particular, what is desired are systems and methods that assist users in organizing or planning ticketed events attended by groups in a more streamlined and user friendly fashion.

### BRIEF DESCRIPTION OF THE DRAWINGS

The included drawings are for illustrative purposes and serve only to provide examples of possible systems and methods for the disclosed organization or planning of group attended ticketed events. These drawings in no way limit any changes in form and detail that may be made to that which is disclosed by one skilled in the art without departing from the spirit and scope of this disclosure.

FIG. 1 illustrates in block diagram format an exemplary computing system adapted for implementing one or more processes involving the organization of group attended ticketed events according to one embodiment of the present invention.

FIG. 2 illustrates in block diagram format an exemplary computer system suitable for implementing on one or more devices of the computing system in FIG. 1 according to one embodiment of the present invention.

FIG. 3A provides a flowchart of an exemplary method of inviting friends to a ticketed event according to one embodiment of the present invention.

FIG. 3B provides a flowchart of an exemplary method of paying for attendees to a ticketed event according to one embodiment of the present invention.

FIG. 4 illustrates a screenshot of an exemplary service provider interest page offering multiple tickets to a ticketed event of interest that can be split amongst a plurality of attendees according to one embodiment of the present invention.

FIG. 5 illustrates a screenshot of an exemplary service provider landing page displaying a plurality of tickets to a ticketed event according to one embodiment of the present invention.

FIG. 6 illustrates a screenshot of an exemplary service provider event page displaying details, available tickets, commentary, and other items for a ticketed event according to one embodiment of the present invention.

FIG. 7 illustrates a screenshot of an exemplary service provider event page with a directed invitation to pay for tickets to a ticketed event according to one embodiment of the present invention.

FIG. 8 provides a flowchart of an exemplary method of facilitating the attendance of a plurality of persons at a ticketed event according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

The present invention relates in various embodiments to devices, systems and methods involving activities with respect to group attended ticketed events. In various particular embodiments, the subject group ticketing devices, systems or methods can involve one or more user devices in communication over a network. Such a network can facilitate a streamlined process involving the discovery, inviting, discussion and purchase of tickets for a group of event attendees.

While the various examples disclosed herein focus on particular aspects regarding ticketed events attended by groups, it will be understood that the various inventive principles and embodiments disclosed herein can be applied to other types of ticketed applications and arrangements as well. For example, an event to be attended by only one or two people may utilize one or more of the various aspects and features found in the various systems and methods provided.

### Systems and Devices

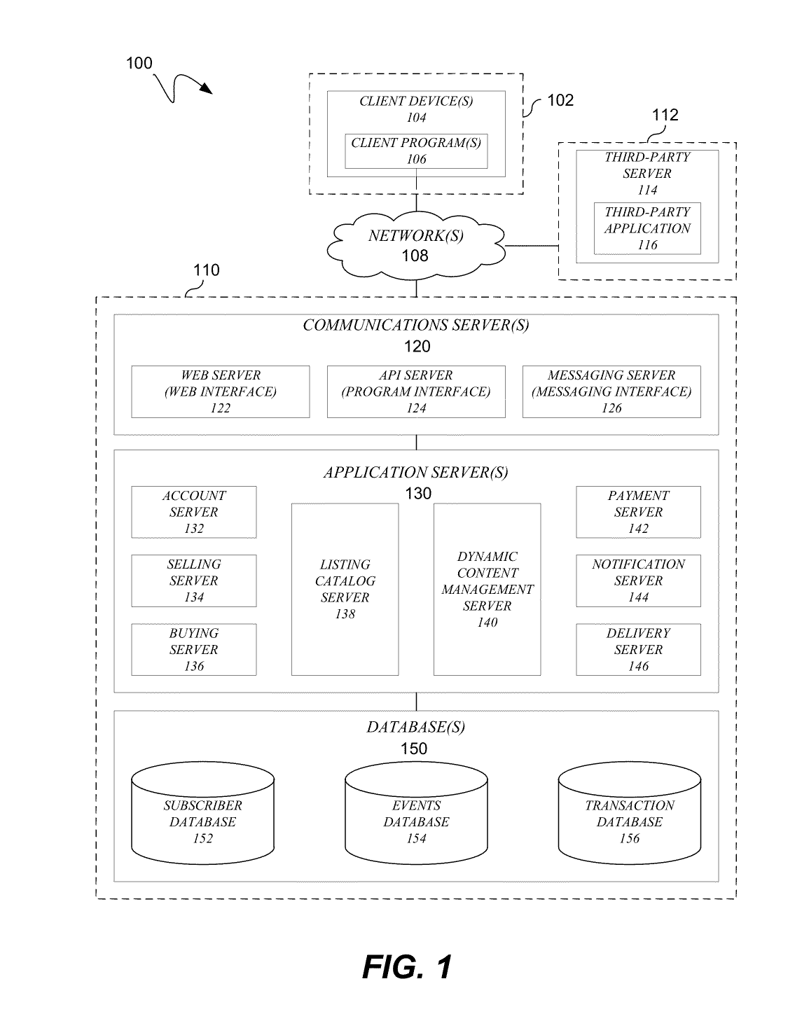

Beginning with FIG. 1, an exemplary embodiment of a computing system adapted for implementing one or more processes involving the organization of group attended ticketed events is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC, and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as additional ticket inventory. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. Further details regarding the various components, capabilities and features of computing system 100 can be found at, for example, U.S. patent application Ser. No. 13/293,854, entitled “Intelligent Seat Recommendation,” filed on Nov. 10, 2011, which is incorporated herein by reference in its entirety.

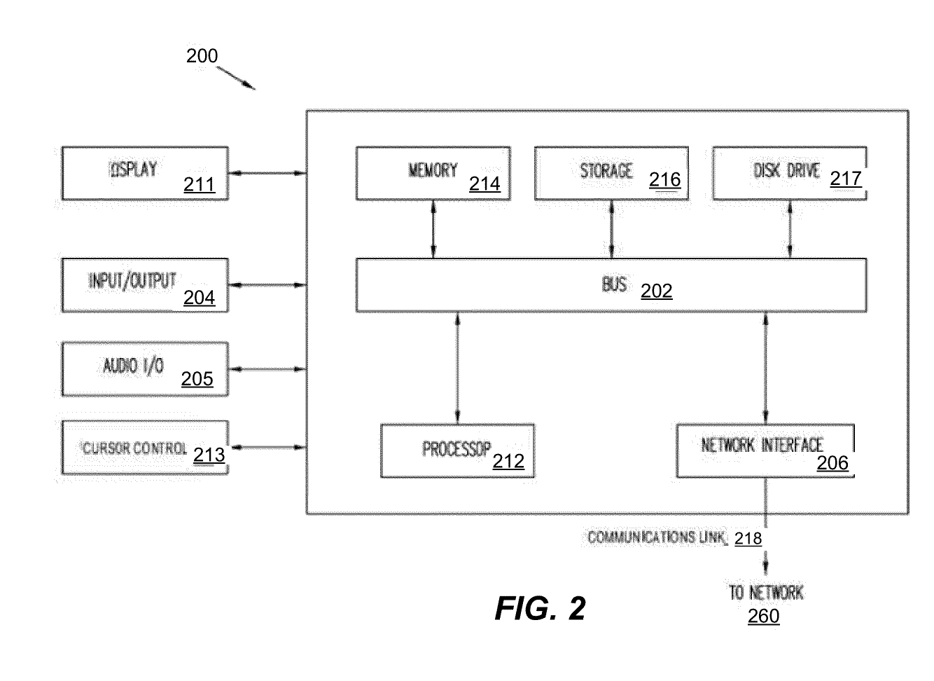

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In one embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise.

### Group Ticketing

As will be readily appreciated, the foregoing networks, systems, devices, and numerous variations thereof can be used to implement the improved organizing or planning of ticketed events attended by groups in a more streamlined and user friendly fashion. Rather than having users resort to known procedures involving separate and often manual steps of searching for tickets, contacting friends, buying tickets online, organizing travel plans, collecting money from friends, and the like, a more automated and integrated system, user interface and process can be provided. In various embodiments, a ticketed event for a user can be determined either by user selection or by a suggestion from a service provider, such as, for example, eBay Inc. of San Jose, Calif.

Service provider suggestions can be based on user information, profile or preferences, for example. Friends, family, coworkers and/or other group members can then be invited to the event as selected by the user and/or as suggested by the service provider. Such invite suggestions can be made through knowledge of the user and friends, such as likes in music, social and business contacts and friends, types and locations of events, social networking parameters, and the like. Tickets may be suggested by the service provider based on user or group preferences, such as general admission seats, loge seats, front row seats, and so forth. When a group of interested buyers is determined, such as by one or more invitees responding affirmatively to an invite, the tickets for the group can be purchased by the user. In some embodiments, the user can pay for the tickets immediately, whereupon the service provider sends notifications to the others and tracks payments from the group to the user. In some embodiments, the service provider can send payment requests to the other invitees, and once one or more payments are received, the user may then purchase the tickets. The service provider can handle the payment and tracking of payments by individuals in the group, and group members can chat about the event through the user interface. Various other details and features may also be included, as will be appreciated.

In various embodiments, one or more systems and methods that assist users in organizing or planning ticketed events attended by groups in a more streamlined and user friendly fashion can involve specialized hardware and/or computer programs. Such hardware and/or programs can be located on user devices, on system servers, and/or distributed across an overall network. An overall brand or name for such systems and methods for group ticketing can be used, such as, for example, a “Go Together” service or package offered by a service provider. General phases for users of such a service can include, for example:
Get Inspired
Confirm Participation
Ticket Selection
Ticket Payments
Event Planning
Event Enjoyment
Post-Event Activity
   Of course, other phases can also be used and/or substituted for any of these examples.

A “Get Inspired” phase can comprise an initial phase of the process, and can involve identifying or suggesting a ticketed event to a user. Such an initial phase can involve a user identifying or selecting a ticketed event of interest on his or her own. Alternatively, a system provider can reach out to the user with suggestions for events that the user might enjoy. Such suggestions or “inspirations” can be provided when the user comes to the website of or otherwise utilizes the service provider. Suggestions can be made based upon a number of informational items that can be specific to the user. Such informational items can include, for example, user profile information and preferences, user purchase history, user browse history, friend recommendations, user tagged favorites, social networking information, and external information, among other possible sources.

User tagged favorites can include information with respect to, for example, artist, venue, team, location, show, and the like. Social networking information can include likes, interests, past events, wants, owns and so forth, such as may be found on social networking websites such as Facebook, YouTube, Twitter, Linkedln, Yelp, MeetMe, MyYearbook, Google+, MySpace, Pinterest, and the like, among other possible websites. External information can include song or artist lists on a separate user device or profile, as well as data from media websites or applications, such as Pandora, Spotify, iTunes, and the like.

In various embodiments, ticketed events can be social or recreational events, such as concerts and sporting events. Alternatively such events can be business related events, such as business meetings, conferences, retreats, and the like. The user-defined criteria for such recreational events can include the names of specific friends who the user wants to know are attending. Other user-defined criteria for such recreational events can include attributes of people such as their sex, age, or any other attributes for which information can be obtained. The user-defined criteria for business related events can include the names of co-workers, superiors (supervisors, managers, officers of a company, members of a board of directors, stockholders, and the like), employees, guests (such as guest speakers) and the like who the user wants to know are attending.

The user-defined criteria for any events can include shared social attributes. Such social attributes can include likes, dislikes, ages, sexes, and the like. Different social attributes can be used with different types of events. For example, the user may want to attend baseball games only with other beer drinkers (or conversely, the user may want to attend baseball games only with other non-drinkers). In this manner, the user can apply social filtering to the event. User-specified types of events can be filtered out or omitted. For example, if the user does not want to attend basketball games, then basketball games can be omitted from the set of possible suggested events. User-specified types of events can be highlighted. For example, if the user is particularly interested in attending hockey games, then hockey games can be preferred for suggestion. The events can be filtered on any desired criteria. For example, the events can be filtered on other criteria such as venue size, type of food served, type of beverages offered (such as alcoholic vs. only non-alcoholic), smoking vs. non-smoking, type of seating (plush vs. hard), and the like.

In various embodiments, the service provider can make suggestions for a particular group of people based upon a group of friends, as might be determined through a social network, a contact list, or any other suitable list. Such a list might be that which can be created by a given user or “organizer.” The suggestions can be for events and/or for invitees, and again can be based on a determination of a shared interest in a venue, a music genre, an artist, a sport, a team, and/or other factors, such as location. Once “inspired” by such suggestion(s), a given user or organizer can pick the appropriate event or events that he or she would like to attend with his or her family, friends, coworkers and/or other potential group members.

A “Confirm Participation” phase can comprise a subsequent process phase where a user or organizer invites and receives responses from one or more persons to attend the ticketed event. Such a phase can involve the user or organizer selecting individual or group invitees manually. Alternatively, or in addition to such manual selection, the service provider can suggest possible invitees based upon one or more factors. Similar to the foregoing, such factors can be based on a determination of a shared interest in a venue, a music genre, an artist, a sport, a team, and/or location, among other possibilities.

Invites to the one or more invitees can be sent through a variety of possible ways, such as, for example, e-mail, text messages, voice messages, and/or social networking sites, such as Facebook, Google+, MySpace, and the like. A number of informational items can be included in the invite, such as, for example, the selected event or events, the availability of tickets in different sections and/or price ranges, the number of tickets available, and who else might be invited and/or confirmed as attending. In various embodiments, the user or organizer can send out invites to one or more ticketed events that he or she thinks can be interesting to the group. Some invites may include one or more different ticketed events, and not all invitees need be invited to all selected events. Invitees can then check off every event that they are invited to attend and would be willing to or interested in attending, as applicable.

Available tickets, sections and/or price ranges can be obtained or provided to the user by way of structured data from the service provider and/or other sources. Such data can be presented to the user or organizer in a manner so as to readily facilitate the selection of preferred section and/or pricing options that may be suitable for a given group of invitees. Such section or pricing options can be variable or varied depending upon the number of people indicating interest and the preferred section or pricing of the organizer, the confirmed invitees and/or potential invitees, such that all members of the group can be seated together or near one another. In some embodiments, invitees can be provided with the ability to mark or indicate in which section or sections they would be willing to attend. Such indications can include, for example, an ability to check affirmatively one, some or all sections or potential seating arrangements, as well as to show that the invitee would be willing to pay more for better seats. Another option can be to allow invitees the ability to purchase one or more tickets to a selected event, such as where an invitee might be interested in also taking minor children to the event.

A “Ticket Selection” phase can comprise a process phase where the user or organizer acts upon responses from the invitees so as to select and purchase tickets to attend the ticketed event. Once an organizer gets responses back from his or her invitees, there can be an understanding of which event most people want to attend and where everyone wants to sit (with associated price ranges). At such a time, the service provider can present a PDP (“Product Details Page”) or other suitable display presentation for the event to the user.

Results can be organized or constrained by the section/prices that the invitees/group has decided upon, although the organizer might be given the ability to change refinements if needed in order to make things work. On the PDP or other suitable presentation, the service provider can include information from the friends and/or other invitees who want to go to the selected ticketed event. Such information can include the names and/or pictures of the confirmed invitees, as well as their preferences for sections, prices, quantity of tickets, and/or other concerns. Once the organizer has found the right tickets, he or she can go to the appropriate service provider display or page and select one or more payment or additional action options. Such options can include, for example a “Split with Friends” option, a “Buy it Now” option, a “Make Offer” option, and/or an “Add to Cart” option, among other possible options and features.

A “Ticket Payments” phase can comprise a process phase where suitable payment(s) are made for the tickets to attend the ticketed event. This can occur in any of a number of ways, such as by each accepted invitee (i.e., attendee) paying his or her own way directly online, the user or organizer paying for the whole group online and getting a reimbursement from the various attendees, a combination thereof, or any other suitable payment plan.

In some embodiments, if the original user or organizer has clicked on a “Split with Friends” option, then he or she can go to a suitable page where the service provider can automatically split up the proper number of tickets and associated costs to each attendee. The organizer and/or attendees can revise the costs to individual attendees as desired for a particular group or event. For example, if the ticket for one attendee is a gift from the organizer, then the organizer can “zero” the cost for that attendee and add that amount to the cost to the organizer. In various embodiments, the organizer can enter his or her online account information. The service provider can then enable the organizer to send invites or “payments due” out to attendees to pay for their tickets and/or be notified of a ticket purchase. At this point, the organizer can be presented with at least two options. First, the organizer can buy the tickets and then collect contributions from friends after payment. Alternatively, the organizer can wait for contributions and then buy the tickets. Such a wait can involve waiting for suitable contributions from all attendees before making payment. In the event that the organizer pays up front, the attendees can then pay back the organizer with a credit card or PayPal, for example.

In some embodiments, if the original user or organizer has clicked on any of the “Buy it Now,” “Make Offer,” or “Add to Cart,” options, then the flow can be somewhat different. In such instances, the organizer can continue through to the checkout of the service provider, whereupon a successful checkout can result in a similar option to “Split with Friends” option. If the user clicks then on the “Split with Friends” option, he or she can then be taken to the “Split with Friends” page or display as may be suitable. In such instances, everything can then work as in the above description. After sending invites under this alternative, the user or organizer will no longer have to choose between buying tickets now or later, since the user will have already purchased them, as will be readily appreciated.

An “Event Planning” phase can involve a process phase where suitable transportation plans, pre and post event dining, and other issues are discussed and/or resolved regarding the ticketed event. This can occur in any of a number of ways, such as by some automation or display by the service provider, as well as each attendee providing input, discussion and actions regarding these items.

In some embodiments, attendees can be taken to a “My Event” or other suitable page once the organizer invites the attendees to pay for the event tickets. Similarly, those that are invited to chip in can go to the “My Event” page for the event to which they have been invited. Access points for such a “My Event” or other similar suitable page can include those for the organizer, the paid attendees, the confirmed attendees, further invitees, and/or other contributors. A “My Events” page, tab, bar or other functionality can involve a URL in emails/messages to the organizer and/or some or all of the other access category types. The “My Event” or other suitable page as provided by the service provider can include any number of tools or features to help facilitate various event-planning tasks. Such tools or features can include, for example, a discussion board, a chat room, merchandising options for the event (e.g., gear, memorabilia, parking passes, etc.), dining and service suggestions (e.g., Yelp reviews), information and tools regarding transportation (e.g., parking information, public transit options, payment interface), map features and integration, coupons or other promotional items relative to the ticketed event, and a variety of additional content. Such additional content can include, for example, news articles, images, music samples, set lists from prior shows, cast members, sports statistics and standings, and event reviews or previews, among other possible relevant items.

An “Event Enjoyment” phase can involve the process phase where the attendees are actually at the ticketed event. A variety of activities can take place during such an enjoyment phase, some of which may be captured on or facilitated by a website or application of the service provider.

In some embodiments, various during event activities and features can include mobile downloads and uploads with respect to check-ins, pictures, videos, QR coded check-ins, submitting live set lists or requests, writing real time previews or reviews based on firsthand experiences, accessing targeted or event specific coupons or deals, and activating “bump” type payments or transfers, among other items.

A “Post Event Activity” phase can involve a final process phase where any number of actions or activities after the ticketed event can take place as facilitated by the service provider. Such actions can include finalizing any payments or monetary transfers that might need to be resolved. Activities can also include the delayed uploading or posting of pictures, video, reviews, commentary or other relevant content. Ongoing message board and/or chat room discussion can also be included in such a post event phase, as well as other possible activities.

As noted with respect to FIG. 2 above, a computer system 200 can include one or more processors 212 and one or more memories or storage devices 214, 216. Such a computer system 200 can be part of a user device, part of one or more servers on a network-bases system, or some combination thereof. In particular, a given computing system can include a first memory device or storage component adapted to store information regarding one or more users of the system, as well as a second memory device or storage component adapted to store event information regarding a plurality of upcoming ticketed events. The event information can include information regarding what the event is, when and where the event is happening, and what tickets, sections and pricing are available for the ticketed event. In some embodiments, a single memory device or storage component can be used to store information regarding users as well as upcoming ticketed events.

In addition, one or more processors 212 can be adapted to facilitate displaying information regarding a ticketed event, accepting an input from a user for inviting one or more invitees to the ticketed event, communicating one or more invitations to the one or more invitees based on the input, receiving invitee response information from at least one of the one or more invitees regarding interest in attending the ticketed event, and accepting a purchase request for a plurality of tickets to the ticketed event from the user, wherein the purchase request is based at least in part on the invitee response information.

Further functionality of the one or more processors 212 can include facilitating providing the response information to the user, sending payment requests to one or more invitees for whom tickets are purchased, and communicating regarding the ticketed event between the user, any or all of the one or more invitees, or any combination thereof. Event information can include information regarding the identity of a first event, when and where the first event is happening, and what tickets, sections and pricing are available for the first event. The ticketed event can be a suggested ticket event based on information about the user, such as user browsing history, purchase history, social information, or interest of the user. In addition, the one or more invitees can be determined using a contact list or a social network of the user, and the one or more invitations can be communicated to the one or more invitees using e-mail, text messages, voice messages, and/or social networking sites.

### Methods

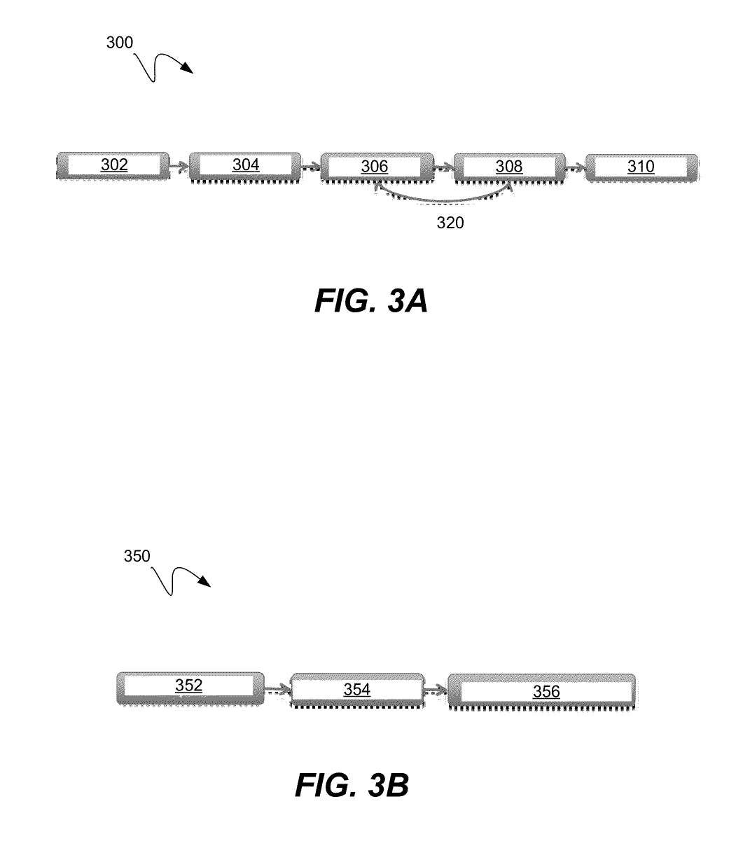

Turning next to FIG. 3A, a flowchart of an exemplary method of inviting friends to a ticketed event is provided. Flowchart 300 represents a simple page flow from a services provider interest page 302, to a landing page 304, to a login page 306, to a success page 308, and finally to an event page 310. The event page 310 can be, for example, a “My Event” page such as that which is described above, or any other suitable end event page. Interactivity 320 between the login page 306 and success page 308 can represent the various invites that are sent from a user to the invitees, as well as the successful establishment of a group event.

Continuing with FIG. 3B, a flowchart of an exemplary method of paying for attendees to a ticketed event is shown. Flowchart 350 similarly represents a simple page flow from a services provider from an initial invite page 352, to an event page 354 and finally to a successfully paid event page 356. As noted above, the invites can be made via e-mail, text message, Facebook or other social networking site, or any other suitable means.

Various screenshots of exemplary pages from the simple page flows of FIGS. 3A and 3B will now be provided for purposes of illustration. It will be understood that such screenshots and pages are not intended to be limiting, and that these merely provide examples of what such pages may contain. Furthermore, not every noted page need be provided for a given service provider, and additional pages not shown or described might also be included in some instances.

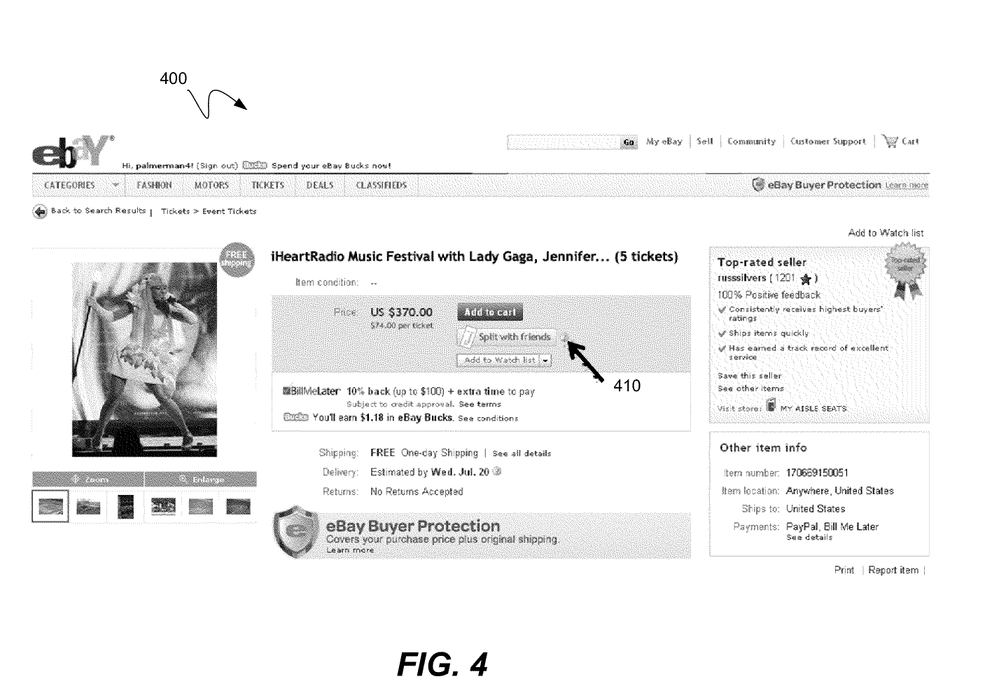

FIG. 4 illustrates a screenshot of an exemplary service provider interest page offering multiple tickets to a ticketed event of interest that can be split amongst a plurality of attendees according to one embodiment of the present invention. Interest page screenshot 400 represents one example of what might be depicted for item 302 of FIG. 3A, and can include a variety of items, such as a title, picture(s), seller, price, and description of a ticketed event. In addition, an icon, label or interactive button 410 can indicate that the number of tickets for sale can be split amongst a plurality of buying parties. For example, 5 tickets might be paid for at the service provider site by anywhere from 1 to 5 different buyers. Such buyers can include an original user and 1 to 4 invitees, such as that which is described in detail above.

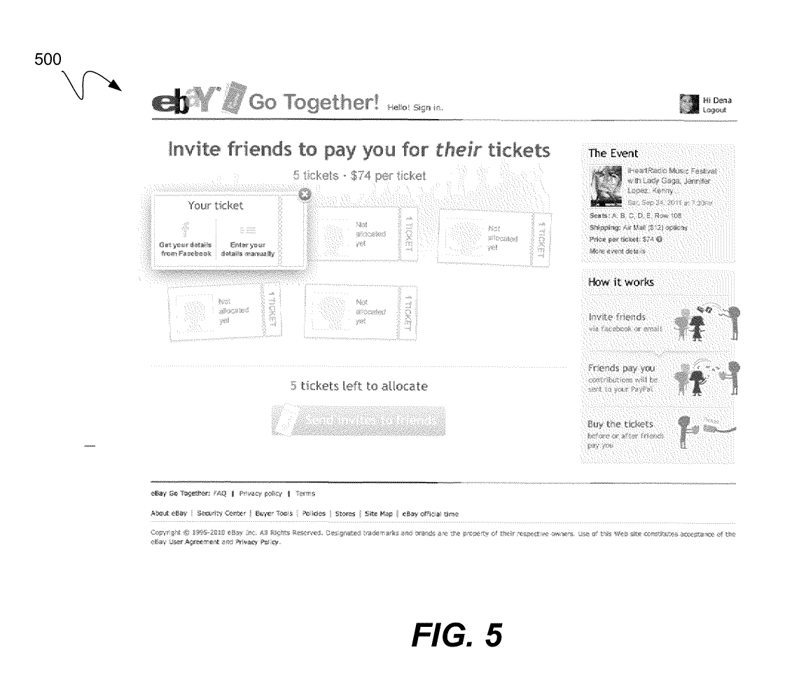

FIG. 5 illustrates a screenshot of an exemplary service provider landing page displaying a plurality of tickets to a ticketed event. As shown in landing page screenshot 500, which represents one example of what might be depicted for item 304 of FIG. 3A, a plurality of tickets can be associated with the ticketed event in interest page 400. In this example, five tickets are available. Each of the five separate tickets can have a set price, and each ticket can be claimed and paid for by a different buyer, user or invitee. Alternatively, one or more buyers can purchase more than one of the five separate tickets. As shown, a button or other interactive icon can be actuated to send out invites to one or more family members, friends, coworkers or other invitees to the ticketed event of interest. After landing page 500, login and success pages (not shown) may also be used as part of the page progression.

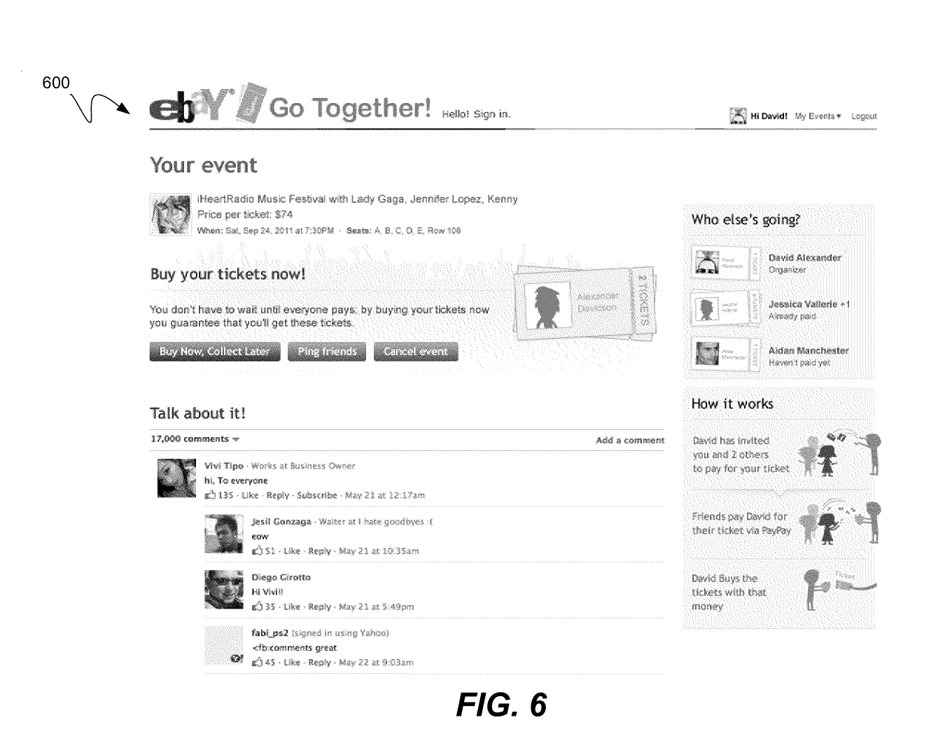

Moving to FIG. 6 a screenshot of an exemplary service provider event page displaying details, available tickets, commentary, and other items for a ticketed event is depicted. Event page screenshot 600 represents one example of what might be depicted for item 310 of FIG. 3A, and can provide a specific ticketed event, details thereof, message board regarding the event, indications of who else is going to the event, an invitation to buy one or more tickets to the event, and instructions as to how to accomplish such a purchase, among other possible items. In the event that a user or invitee does decide to purchase tickets, then the page flow moves from that which is shown in FIG. 3A to the simple page flowchart of FIG. 3B.

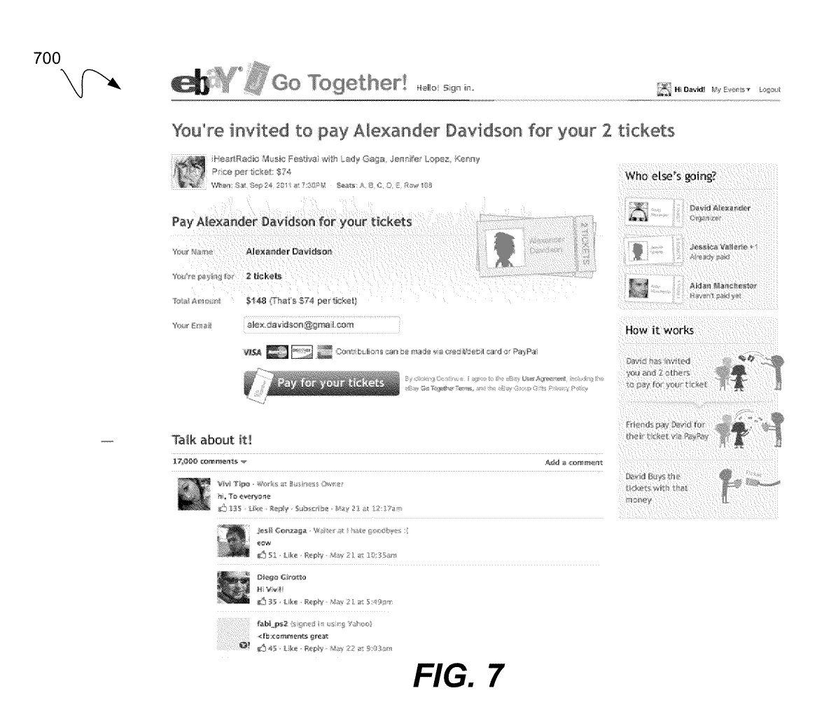

FIG. 7 illustrates a screenshot of an exemplary service provider event page with a directed invitation to pay for tickets to a ticketed event according to one embodiment of the present invention. This screenshot 700 represents one example of what might be depicted for item 354 of FIG. 3B, and can be similar to the event page 310 shown above. One notable difference is that more specific information is provided with respect to payment for tickets by the individual user or invitee that has accessed this page. A subsequent successful payment page could then indicate to the user or invitee that payment has been accepted.

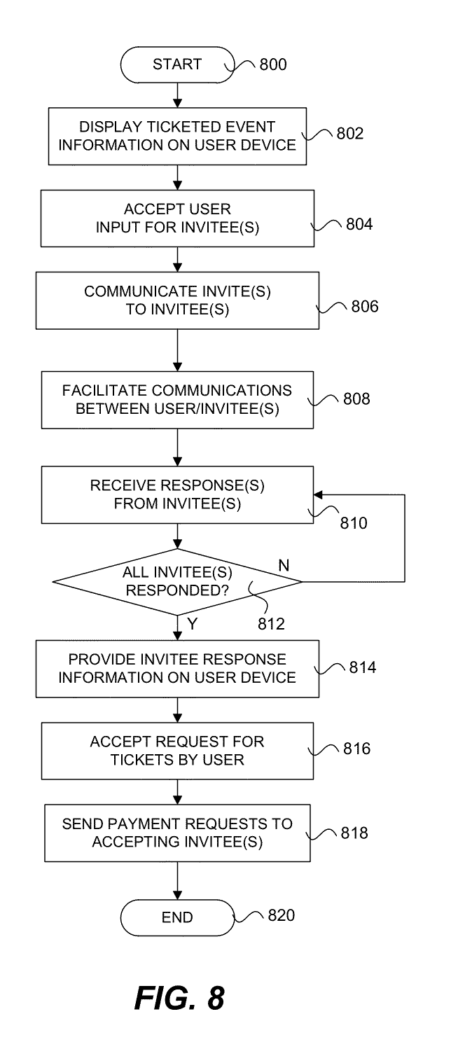

Although a wide variety of applications and methods involving such group ticketing organizations including invites, acceptances and purchases might be envisioned, one basic method is illustrated here. Turning lastly to FIG. 8, a flowchart of an exemplary method of facilitating the attendance of a plurality of persons at a ticketed event is provided. In particular, such a method can involve using or operating any of the various computing components, devices, systems and/or networks described above. It will be readily appreciated that not every method step set forth in this flowchart is always necessary, and that further steps not set forth herein may also be included. For example, additional steps can include suggesting ticketed events and accepting payments, among others. Furthermore, the exact order of steps may be altered as desired for various applications. For example, step 808 can be performed in a number of different locations in the process.

Beginning with a start step 800, ticketed event information is displayed on a user device at process step 802. A user input regarding selecting or designating one or more invitees is accepted at process step 804, after which the invite(s) are then sent or communicated to the invitee(s) at process step 806. Communications between the user and/or invitee(s) are then facilitated at process step 808, upon which one or more affirmative or negative responses from the invitees are received at process step 810.

At subsequent decision step 812, an inquiry can be made as to whether all of the invitees have responded. In the event that not all invitees have responded at step 812, then the method reverts to step 810 until all responses have been received. When responses from all invitees have been received at step 812, then the method continues to process step 814. In various embodiments, step 812 may be omitted, such as where all available tickets have been taken before all invitees have responded. Alternatively, the method may be permitted to continue where a small number of invitees simply do not respond.

At subsequent process step 814, invitee response information is provided on the user device, after which a request for tickets by the user is accepted at process step 816. Such a ticket request can reflect the information obtained in the various invitee responses, for example. Payment requests to the accepting invitees (i.e., now attendees) can be sent at process step 818, after which the method can finishes at an end step 820. Further steps not depicted can include, for example, accepting payments and suggesting ticketed events and/or invitees based upon user profile information or history. Other steps can include, for example, facilitating the posting of event photos, videos, statuses, reviews and other items, as may be desired.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A computing system, comprising:
one or more memory device or storage components adapted to store user information regarding one or more users of the computing system and event information regarding a plurality of upcoming ticketed events; and
one or more processors in communication with the one or more memory device or storage components and adapted to facilitate displaying information regarding a ticketed event, accepting an input from a user for inviting one or more invitees to the ticketed event, communicating one or more invitations to the one or more invitees based on the input, receiving invitee response information from at least one of the one or more invitees regarding interest in attending the ticketed event, and accepting a request for a plurality of tickets to the ticketed event from the user, wherein the request is based at least in part on the invitee response information.

2. The computing system of claim 1, wherein the event information includes information regarding the identity of a first event, when and where the first event is happening, and what tickets, sections and pricing are available for the first event.

3. The computing system of claim 1, wherein said one or more processors is further adapted to facilitate providing the response information to the user.

4. The computing system of claim 1, wherein the ticketed event is a suggested ticket event based on information about the user.

5. The computing system of claim 4, wherein the suggested ticketed event is suggested based on at least one of a browsing history, a purchase history, social information, or interest of the user.

6. The computing system of claim 1, wherein said one or more processors is further adapted to facilitate the sending of payment requests to one or more invitees for whom tickets are requested.

7. The computing system of claim 1, wherein the one or more invitees are determined using a contact list or a social network of the user.

8. The computing system of claim 1, wherein said one or more processors is further adapted to facilitate communications regarding the ticketed event between the user, any or all of the one or more invitees, or any combination thereof.

9. The computing system of claim 1, wherein the one or more invitations are communicated to the one or more invitees using e-mail, text messages, voice messages, and/or social networking sites.

10. A non-transitory medium having a plurality of machine-readable instructions which, when executed by one or more processors of a server controlled by a service provider, are adapted to cause the server to perform a method comprising:
communicating to a user on a separate user device information regarding a ticketed event;
receiving an input from the user regarding inviting one or more invitees to said ticketed event;
facilitating the communication of one or more invitations to the one or more invitees based on the input;
receiving response information from at least one of the one or more invitees regarding interest in attending the ticketed event;
providing the response information to the user; and
accepting a purchase request for a plurality of tickets to said ticketed event from the user, wherein said purchase request is based at least in part on the invitee response information.

11. The non-transitory medium of claim 10, wherein the ticketed event is a suggested ticket event based on information about the user.

12. The non-transitory medium of claim 11, wherein the suggested ticketed event is suggested based on at least one of a browsing history, a purchase history, social information, or interest of the user.

13. The non-transitory medium of claim 10, wherein the method further comprises the step of:
sending payment requests to one or more invitees for whom tickets are purchased.

14. The non-transitory medium of claim 10, wherein the one or more invitees are determined using a contact list or a social network of the user.

15. A method of facilitating the attendance of a plurality of persons at a ticketed event, the method comprising:
displaying on a computing device to a user thereof information regarding a ticketed event, said displaying being performed electronically by a processor;
accepting on the computing device an input from the user regarding inviting one or more invitees to said ticketed event;
facilitating the communication of one or more invitations to the one or more invitees based on the input;
receiving at the computing device invitee response information from at least one of the one or more invitees regarding interest in attending the ticketed event;
providing the response information on the computing device; and
accepting on the computing device a request for a plurality of tickets to said ticketed event from the user, wherein said request is based at least in part on the invitee response information.

16. The method of claim 15, wherein the ticketed event is a suggested ticket event based on information about the user.

17. The method of claim 16, wherein the suggested ticketed event is suggested based on at least one of a browsing history, a purchase history, social information, or interest of the user.

18. The method of claim 15, further comprising the step of:
facilitating the sending of payment requests to one or more invitees for whom tickets are requested.

19. The method of claim 15, wherein the one or more invitees are determined using a contact list or a social network of the user.

20. The method of claim 15, further comprising the step of:
facilitating communications regarding the ticketed event between the user, any or all of the one or more invitees, or any combination thereof.
